(19) United States
(12) Patent Application Publication
(10) Pub. No.: US 2026/0328430 A1
(43) Pub. Date: Oct. 22, 2026

(54) POWER CAPTURING OR HARNESSING SYSTEM, APPARATUS AND METHOD FOR SAME

(71) Applicant: Eduardo GOMEZ, Hialeah, FL (US)

(72) Inventor: Eduardo GOMEZ, Hialeah, FL (US)

(21) Appl. No.: 19/645,562

(22) Filed: Apr. 13, 2026

Related U.S. Application Data
(60) Provisional application No. 63/792,030, filed on Apr. 21, 2025.

(51) Int. Cl. F24F 12/00; E04H 4/12; F24F 1/38; F24F 1/56

(52) U.S. Cl. CPC F24F 12/00; E04H 4/129; F24F 1/38; F24F 1/56

(57) ABSTRACT

A system includes a housing that can be secured to a condenser unit of an air conditioning system. The system can include a generator designed to collect mechanical energy, such as air pushed from the condenser unit and to convert the mechanical energy into electricity. The generator can be in operable connection with a power storage unit, such that the electricity from the generator can be stored. The power storage unit can be a power grid or can be a battery bank.

### CROSS-REFERENCE TO RELATED APPLICATION

The present application claims priority to U.S. Provisional Application No. 63/792,030, filed Apr. 21, 2025 and titled “POWER CAPTURING OR HARNESSING SYSTEM, APPARATUS AND METHOD FOR SAME”, the entire disclosure of which is hereby incorporated by reference in its entirety.

### FIELD

The presently disclosed technology relates generally to an apparatus, system, and/or method for capturing or harnessing residual energy, for example from any air-type exhaust system, such as an air-cooled chiller or a commercial or residential air conditioning unit. More particularly, in one embodiment, the presently disclosed technology relates to a housing designed to be mounted onto an outdoor air conditioning unit, such that air exhaust can be converted into electrical energy.

### BACKGROUND

In areas with hot climates, such as Florida, Texas, New England, California, and other regions in the Midwest and Southwestern United States to name a few, air conditioning systems often cycle on and off for hours throughout the day and night. This is particularly true during warmer months. Some homes, for example, can run their air conditioning systems continuously for months at a time. This can place a massive strain on the power grid, especially in areas where the infrastructure is aging and outdated. In effect, this could lead to power shortages. While renewable energy technologies are intended to address this issue, the intermittent nature of solar and wind power remains a significant challenge.

Efforts have been made to utilize energy produced from air conditioning systems. For example, U.S. Patent No. 6,365,985 discloses generating electricity from air conditional exhaust, including use of a shroud 21 or funnel and two or more blades 14. However, these and other known systems have drawbacks and disadvantages. For example, use of a shroud or funnel creates undesirable back flow or back draft on the air conditioner 19, which puts additional and undesirable strain on the air conditioner 19 and/or is not an efficient way to harness the energy. Further, small fans or blades 14 are able to generate only a small amount of energy given their size and/or location.

### SUMMARY

There is a need for a system that captures or harnesses residual energy, such as from an air conditioning system that includes one or more condenser units. By generating power from the air which is blowing from the condenser unit to move a generator, energy that would otherwise be wasted can be captured and/or the net power use of the air conditioning system can be reduced. Optionally, the excess or captured energy can be sold back to the power company or stored in a power storage unit, such as a bank of batteries to use for the next air conditioning cycle. The power storage can be done locally or remotely by power companies.

This system would allow the power grid to theoretically solve its demand problems due to lessor demands in hot climates and peak hours or by receiving the generated electricity from these units to counteract the demand requirements. In South Florida, for example, summers pose great strains on energy grids. A solution other than replacing these grids would be a great benefit to the aforementioned energy shortage crisis.

The presently disclosed technology would help solve the existing energy shortage, thus allowing power grids to reduce their total output requirements as they are upgraded to newer technologies. Furthermore, the impact of power outages can be reduced because of the additional power stored in power storage units.

In one embodiment, the presently disclosed technology is directed to a power capturing or harnessing system that can include a housing placed on or secured to a device that is configured to output air flow. The housing can include at top end, an opposing bottom end, and a plurality of sidewalls therebetween. A first set of the plurality of sidewalls can extend perpendicularly to the top and bottom ends. A second set of the plurality of sidewalls can extend at an angle with respect to the top and bottom ends. The second set of the plurality of sidewalls can include one or more openings extending therethrough. The system can further include one or more generators or alternators disposed or enclosed inside or surrounded by the housing. The system can further include at least one fan or fan blade disposed or enclosed inside or surrounded by the housing. The at least one fan or fan blade can be operatively connected to the one or more generators or alternators. Airflow through the housing causes the at least one fan or fan blade to rotate. The one or more generators or alternators captures energy based on rotation of the at least one fan or fan blade and converts the energy into electricity. A Venturi effect is created within the housing when air is flowing through the housing from the second end to the first end.

In another embodiment, the presently disclosed technology is directed to a method of capturing or harnessing airflow generated by a condenser unit of an air conditioning system. The method can include placing a housing on top of a condenser unit of an air conditioning system such that air flow generated by the condenser unit moves at least one fan blade within the housing while generating a Venturi effect through the housing. The method can also include converting the energy produced by the movement of the at least one fan blade into electrical energy via a generator within the housing.

### BRIEF DESCRIPTION OF THE DRAWINGS

The following detailed description of the presently disclosed technology will be better understood when read in conjunction with the appended drawings, wherein like numerals designate like elements throughout. For the purpose of illustrating the presently disclosed technology, there are shown in the drawings various illustrative embodiments. It should be understood, however, that the presently disclosed technology is not limited to the precise arrangements and instrumentalities shown. In the drawings:

FIG. 1 is a perspective view of an exemplary system of one embodiment of the presently disclosed technology.

FIG. 2 is a perspective view of the system shown in FIG. 1 installed on a condenser unit of a residential air conditioning system.

FIG. 3 is a top plan view of the system shown in FIG. 1.

FIG. 4 is a cross-sectional elevation view of the system shown in FIG. 3, taken along line A-A of FIG. 3.

FIG. 5 is a cross-sectional elevation view taken along line A-A of FIG. 3, with multiple generators / alternators within the same system.

FIG. 6 is a perspective view of an exemplary power storage unit that can be used in conjunction with the system shown in FIG. 1.

FIG. 7 is a top plan view of the system with a vertical type generator / alternator.

FIG. 8 is a cross-sectional elevation view taken along line B-B of FIG. 7.

FIG. 9 is a top plan view of an exemplary system of one embodiment of the presently disclosed technology, with multiple vertical generators / alternators.

FIG. 10 is a cross-sectional elevation view taken along line C-C of FIG. 9.

FIG. 11 is a modification of the embodiment shown in FIG. 4, which is a cross-sectional elevation view of the system shown in FIG. 3, taken along line A-A of FIG. 3.

### DETAILED DESCRIPTION

While systems, devices and methods are described herein by way of examples and embodiments, those skilled in the art recognize that the presently disclosed technology is not limited to the embodiments or drawings described. Rather, the presently disclosed technology covers all modifications, equivalents and alternatives falling within the spirit and scope of the appended claims. Features of any one embodiment disclosed herein can be omitted or incorporated into another embodiment.

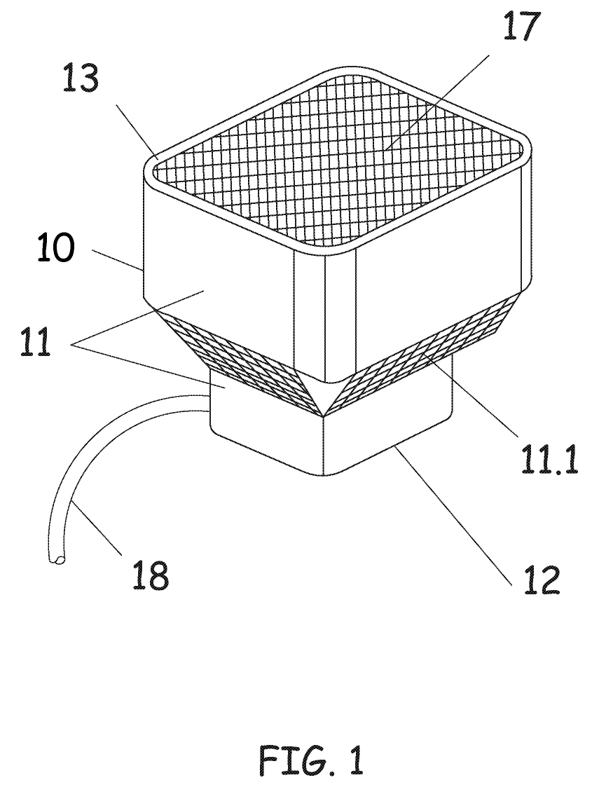

Referring to the drawings in detail, wherein like numerals indicate like elements throughout, FIGS. 1-5 show a system of one embodiment of the presently disclosed technology that is configured to capture and/or harness energy that is outputted from a separate device or unit. The system can include a housing 10 that is optionally sized and shaped to attach to and/or complement an existing separate device or unit 16, such as an outdoor condenser unit of an air conditioning system as explained below.

In the exemplary embodiment, the housing 10 can include a plurality of sidewalls 11, a bottom end 12, and an opposing top end 13. In the exemplary embodiment, the bottom end 12 is at least partially open. Further, in the exemplary embodiment, the top end 13 is at least partially open, optionally with louvers or grates to allow the passage of air therethrough.

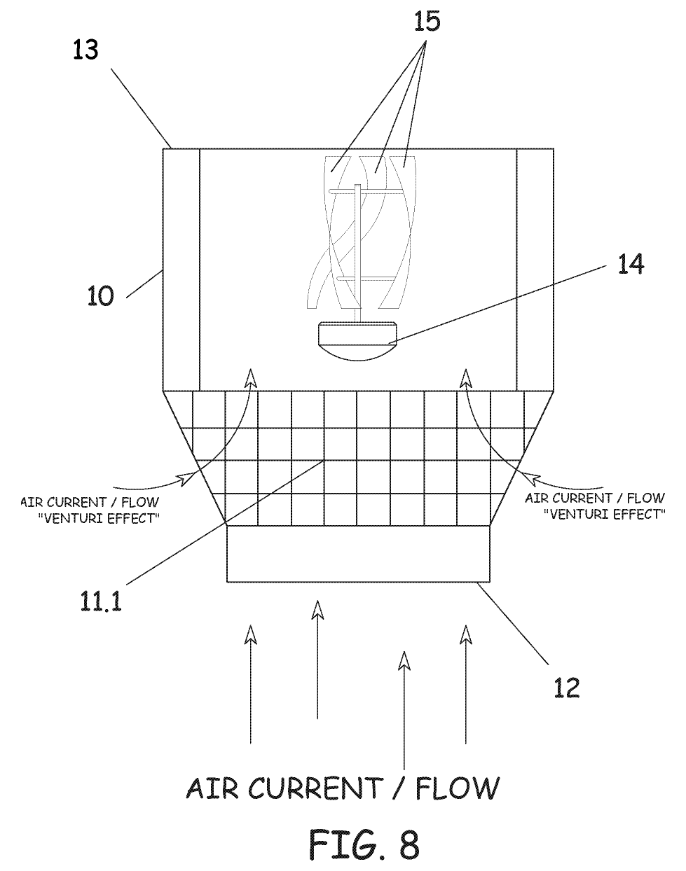

In one embodiment, certain vertically-extending sidewalls 11 can be vertically separated by and connected to other vertically-extending sidewalls by the vented, flared, and/or angled sidewalls 11.1. For example, as shown in FIGS. 1-5 and 7-11, one or more of a first set the sidewalls 11 can be positioned vertically, and/or adjacent sidewalls can extend at 90 degrees from each other. The first set of the sidewalls 11 can be positioned at or proximate to the top end 13 of the housing 10. Optionally, a second set of the sidewall 11.1 can be vented (e.g., one or more spaced-apart openings), flared, and/or angled (e.g., in this instance approximately or exactly 45 degrees) with respect to the top and bottom ends 13, 12 of the housing 10. Optionally, a third set of the sidewalls 11 can be positioned vertically, and positioned at or proximate to the bottom end 12 of the housing 10.

Optionally, a length and width of the top end 13 can be larger than that of the bottom end 12, such that a top of the housing 10 is larger than a bottom of the housing 10. The above-described configuration can assist with desired airflow through the housing 10.

The housing 10 and/or the plurality of sidewalls 11 can be made of a plastic material or a metal material, for example, such that the housing 10 will be sufficiently durable and will withstand environmental conditions, such as high heats, winds, precipitation, and/or other harsh weather conditions.

The housing 10 can be configured to be placed on top of and/or attached to the condenser unit 16 of the air conditioning system. For example, the housing 10 can be secured to the condenser unit 16 by one or more fasteners, such as screws, bolts, and/or brackets. The condenser unit 16 can be a conventional or prior art condenser unit associated with a commercial or residential air conditioning system. Alternatively, the housing can be placed on top of and/or attached to any system or unit that outputs an air current or flow.

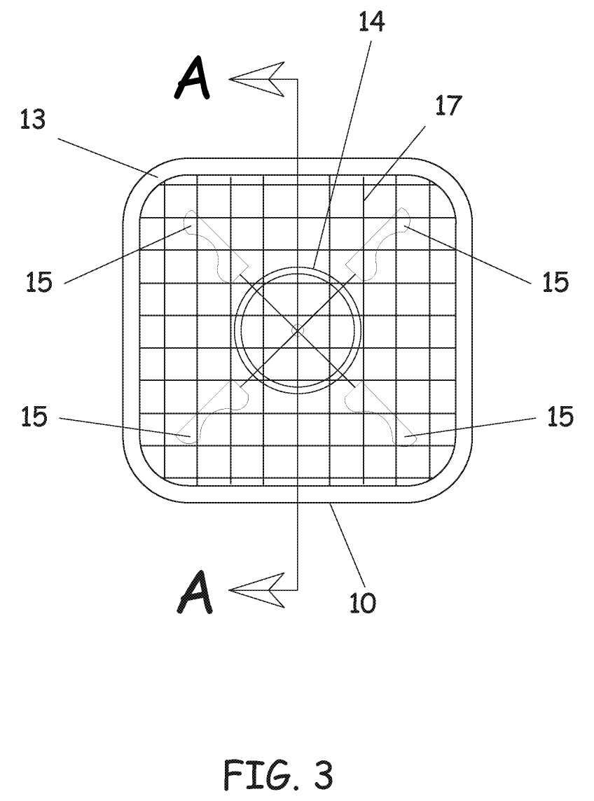

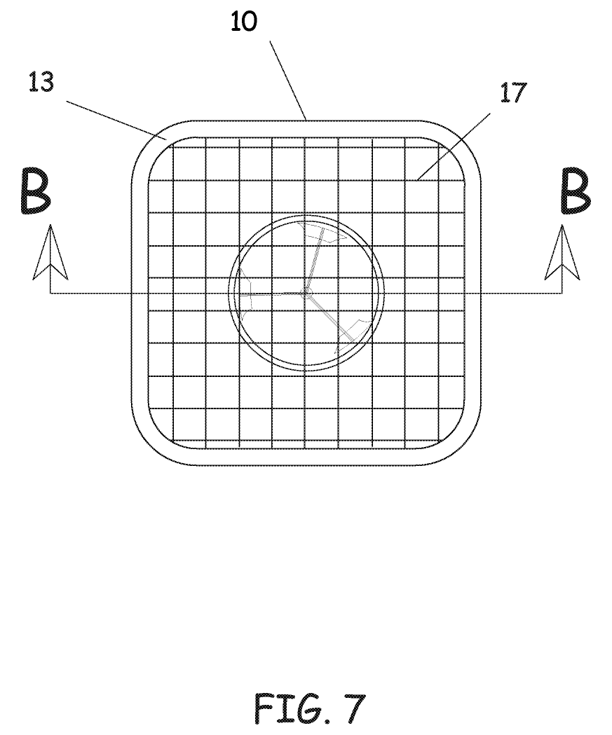

As shown in FIGS. 3-5 and 8-11, one or more generators or alternators 14 can be disposed or enclosed inside or surrounded by the housing 10. In one specific embodiment, the housing 10 can enclose one or more generator or alternator motors 14, as shown in FIGS. 7-10.

In the exemplary embodiments, each generator/alternator 14 is in operable connection with at least one fan 15. The fan 15 can include one or more (e.g., four equidistantly spaced-apart) blades extending radially outwardly from the generator or alternator 14. As shown in FIGS. 7-10, each fan 15 can be a vertical fan type with curvilinear fins extending from a vertical shaft of each generator or alternator motor 14. Air currents directed toward the fan 15 (e.g., in this case, from below) when the air conditioner is operating will cause the fan 15 to rotate. As the fan 15 is rotated, the resulting mechanical energy can be converted into electrical energy by the generator 14.

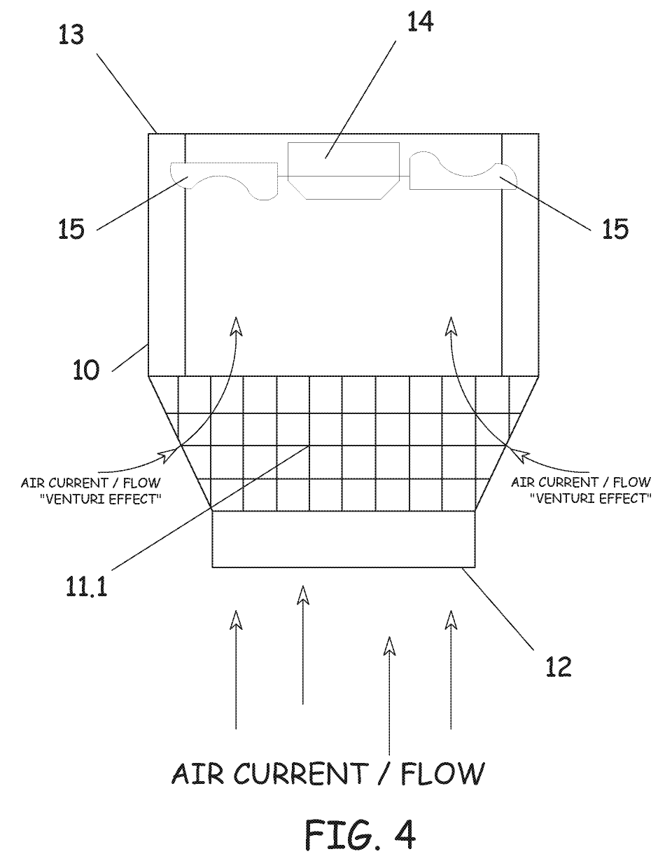

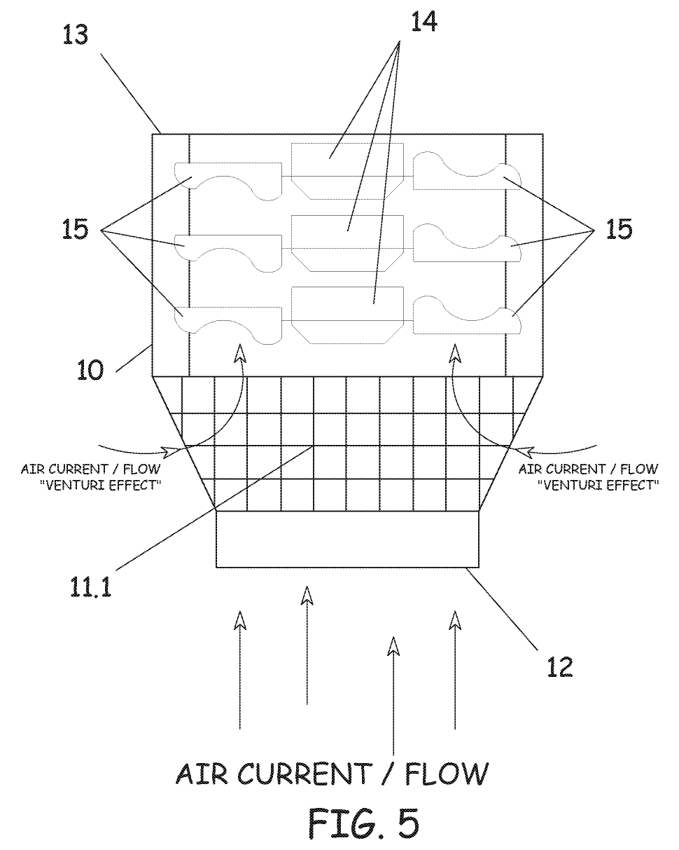

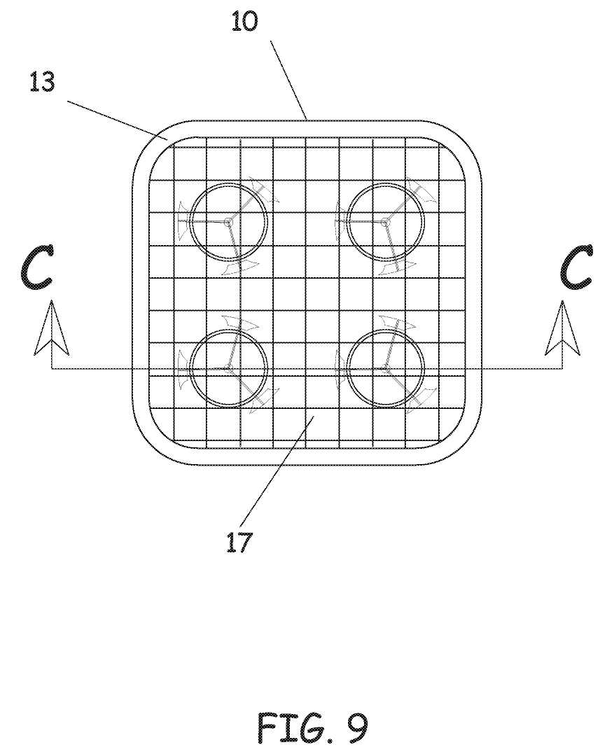

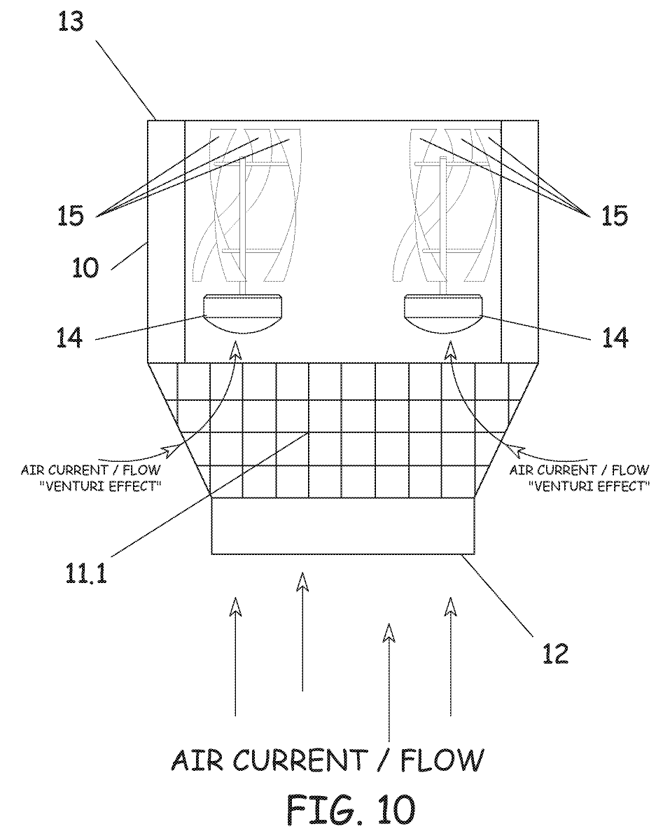

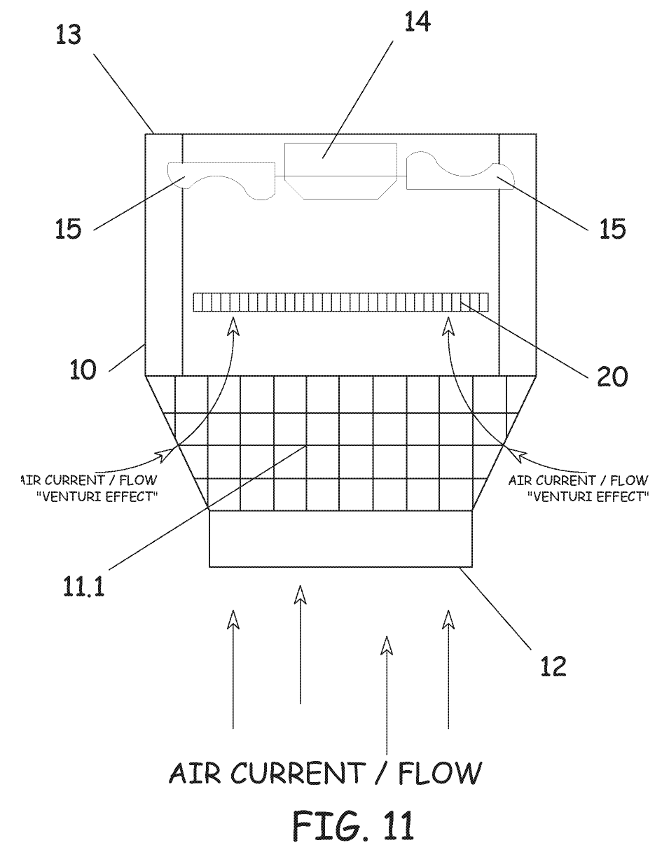

In some embodiments, such as those shown in FIGS. 4 and 11, the generators or alternators 14 can be located closer to the top end 13 of the housing 10 and further from the bottom end 14 of the housing 10. In some embodiments, such as that shown in FIG. 5, the generators or alternators 14 are in vertical alignment. In some embodiments, such as those shown in FIGS. 9 and 10, the generators or alternators 14 are on the same horizontal plane.

As shown in FIGS. 1, 2, 4, 5, 8, 10, and 11, in at least one embodiment, vented with protective grills or other mesh type products, the angled sidewalls 11.1 allow a Venturi effect through the housing 10, which increases the amount of air flow requiring or utilizing without additional power. Those of ordinary skill in the art understand that the Venturi effect is the reduction in fluid pressure that results when a moving fluid speeds up as it is forced from one section of a passageway to another. In addition or alternatively, the housing 10 and/or these sidewalls 11.1 create little or no backflow or backdraft, which is a drawback of the prior art.

In operation of one embodiment, as the condenser unit 16 pulls or transfers ambient air through radiator fins to cool its coils and compress heated refrigerant, a fan of the condenser unit 16 blows air over the condenser to dissipate the heat or hot air outside. The expelled or wasted air exits the condenser unit 16, typically at a top thereof. By positioning the system above the fan of the condenser unit 16, the air pushed by the fan of the condenser unit 16 will drive or result in rotation of the fan(s) 15, in turn providing electrical energy to the alternator/generator(s) 14.

A shield 17 can be included on top of or attached to the top end 13 of the housing 10. The shield 17 can be configured to prevent debris from entering the housing 10 and interfering with the generator/alternator(s) 14. Furthermore, the shield 17 can be configured to prevent accidental injuries to individuals in the area around the power generator system. In an exemplary embodiment, the shield 17 can be a grate, such as to minimize air flow loss from the shield 17.

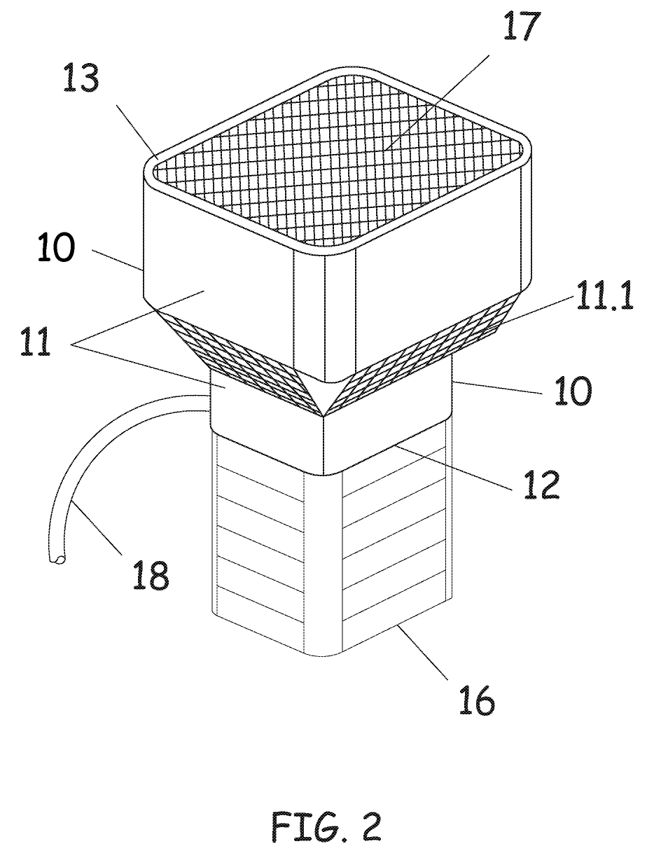

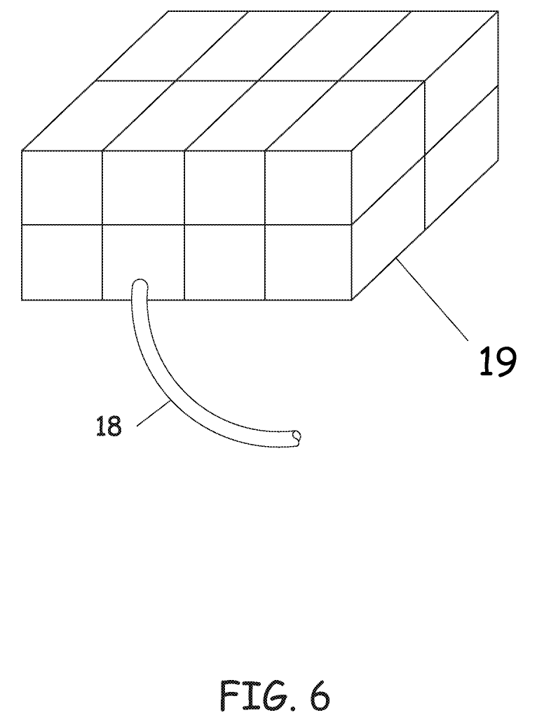

One or more of the generators or alternators 14 can include a power outlet. Each power outlet can be configured to transmit electrical energy from the generator 14 to a separate or different device. In an exemplary embodiment, the power outlet 18 as shown in FIGS. 2 and 6 can provide an operable and/or direct connection between at least one of the generators/alternators 14 and a power storage unit 19. For example, the power storage unit 19 can be a battery bank. Additionally or alternatively, the power outlet 18 can provide an operable connection between at least one of the generators/alternators 14 and a power grid, such that power gathered by the generator(s)/alternator(s) 14 can be fed into a power grid to power other electrical systems and components. Furthermore, the power outlet 18 can be in an operable connection with a home electrical system, such that the electricity can be used by a house to which the air conditioning system is installed. The power can also be sold back to the power companies to assist with high demand times of day.

At least one of the generators/alternators 14 can be in operable connection with a processor, such as a computer. The processor can be configured to collect data regarding the electricity generated by the generator(s)/alternator(s) 14. For example, the processor can track the energy generated by the generator(s)/alternator(s) 14 relative to the energy used by the condenser unit to calculate the efficiency of the power generator system.

In one embodiment, such as that shown in FIG. 11, the housing 10 can include a plurality of fin radiators 20. The plurality of fin radiators 20 can be made of aluminum or another conductive material. The plurality of fin radiators 20 can be configured to receive a liquid supply, wherein the liquid supply is pumped through the plurality of fin radiators, such that the fin radiators can be used to heat the liquid supply. For example, the liquid supply can be pool water, such that the pool pump(s) can be used to pump cold pool water or other liquid through them, then heat pool water or other liquid (e.g., an insulated tank to be used in hot water plumbing system).

While the presently disclosed technology has been described in detail and with reference to specific examples thereof, it will be apparent to one skilled in the art that various changes and modifications can be made therein without departing from the spirit and scope thereof. It is understood, therefore, that the presently disclosed technology is not limited to the particular embodiments disclosed, but it is intended to cover modifications within the spirit and scope of the presently disclosed technology.

What is claimed is:

1. A power capturing or harnessing system comprising:
a housing placed on or secured to a device that is configured to output air flow, the housing including at top end, an opposing bottom end, and a plurality of sidewalls therebetween, a first set of the plurality of sidewalls extending perpendicularly to the top and bottom ends, a second set of the plurality of sidewalls extending at an angle with respect to the top and bottom ends, the second set of the plurality of sidewalls including one or more openings extending therethrough;
one or more generators or alternators disposed or enclosed inside or surrounded by the housing; and
at least one fan or fan blade disposed or enclosed inside or surrounded by the housing, the at least one fan or fan blade being operatively connected to the one or more generators or alternators,
wherein airflow through the housing causes the at least one fan or fan blade to rotate,
wherein the one or more generators or alternators captures energy based on rotation of the at least one fan or fan blade and converts the energy into electricity; and
wherein a Venturi effect is created within the housing when air is flowing through the housing from the second end to the first end.

2. The system of claim 1, wherein the energy is air flow generated by the device.

3. The system of claim 2, wherein the device is a condenser unit of an air conditioner.

4. The system of claim 1, wherein the one or more generators or alternators are operatively connected to a power storage unit.

5. The system of claim 4, wherein the power storage unit is a power grid or a battery bank.

6. The system of claim 1, further comprising a third set of the plurality of sidewalls extending perpendicular to the top and bottom ends of the housing, wherein the third set is located proximate the bottom end of the housing, and wherein the first set is located proximate the top end of the housing.

7. The system of claim 1, wherein the one or more generators or alternators includes at least two generators or alternators that are vertically spaced-apart within the housing.

8. The system of claim 7, wherein the at least one fan or fan blade includes at least two fans that are vertically spaced-apart within the housing.

9. The system of claim 1, wherein the one or more generators or alternators includes at least two generators or alternators that are laterally spaced-apart within the housing.

10. The system of claim 9, wherein the at least one fan or fan blade includes at least two fans that are laterally spaced-apart within the housing.

11. The system of claim 1, wherein the housing includes or surrounds a plurality of fin radiators configured to heat a liquid supply.

12. A method of capturing or harnessing airflow generated by a condenser unit of an air conditioning system, the method comprising:
placing a housing on top of a condenser unit of an air conditioning system such that air flow generated by the condenser unit moves at least one fan blade within the housing while generating a Venturi effect through the housing; and
converting the energy produced by the movement of the at least one fan blade into electrical energy via a generator within the housing.

13. The method of claim 12, wherein the housing includes at top end, an opposing bottom end, and a plurality of sidewalls therebetween, a first set of the plurality of sidewalls extending perpendicularly to the top and bottom ends, a second set of the plurality of sidewalls extending at an angle with respect to the top and bottom ends, the second set of the plurality of sidewalls including one or more openings extending therethrough.

14. The method of claim 12, wherein the housing surrounds or includes at least two generators or alternators that are vertically or horizontally spaced-apart within the housing.

15. The method of claim 12, the method further comprises:
pumping the liquid supply through a plurality of fin radiators within the housing.

16. The method of claim 15, wherein the liquid supply is pool water and the liquid supply is heated before being sent to a pool.

17. The method of claim 12, the method further comprises:
sending the electrical energy to a power storage unit.
